(19) United States
(12) Patent Application Publication
(10) Pub. No.: US 2007/0244241 A1
(43) Pub. Date: Oct. 18, 2007

(54) Resin Composition

(75) Inventors: Gen Masuda, Chiba (JP); Toshifumi Hashiba, Chiba (JP); Kazutoshi Hayakawa, Chiba (JP); Nami Tsukamoto, Chiba (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NISSHINBO INDUSTRIES, INC., TOKYO (JP)

(21) Appl. No.: 11/578,179

(22) PCT Filed: Apr. 11, 2005
(86) PCT No.: PCT/JP05/07021

§ 371 Date: Oct. 11, 2006

(30) Foreign Application Priority Data
Apr. 12, 2004 (JP) 2004-116351

(51) Int. Cl. C08K 9/04; C08L 101/00

(52) U.S. Cl. 524/436; 524/612

(57) ABSTRACT

Disclosed is a resin composition wherein dispersibility of a modifying agent such as an inorganic substance is improved. The acid resistance of this resin composition is not deteriorated even when a modifying agent is blended therein. Specifically, the resin composition includes a base material having a cyano group-containing organic layer and an organic resin. This resin composition is extremely excellent in acid resistance when compared with organic resins which use a base material having an organic layer not containing a cyano group.

### TECHNICAL FIELD

The present invention relates to a resin composition. More specifically, it relates to a resin composition which includes a base material having on the surface a cyano group-bearing organic layer.

### BACKGROUND ART

Organic resins are processed into film and other shaped articles, and used in a variety of applications.

To enhance the physical properties of the shaped article thus obtained or endow it with special capabilities, inorganic substances are often added as modifiers to the organic resin. Shaped articles made of compositions obtained by adding a modifier to an organic resin in this way are thus endowed with a combination of the characteristic qualities of the modifier and the organic substance, making them useful in a broad range of applications.

However, when a modifier such as an inorganic substance is added to a base resin, if the modifier lacks sufficient dispersibility in the resin, a high loading of the modifier in the base resin will be difficult to achieve. As a result, the improvement in the target physical properties will fall short of what is desired. Hence, it is very important to increase the compatibility between the resin and the modifier, and the dispersibility of the modifier in the base resin.

In particular, inorganic substances generally have a poor dispersibility in resins. Therefore, when it is necessary to add an inorganic substance to a resin, the inorganic substance is often mechanically dispersed using a ball mill, for example, or the dispersibility is increased by the concomitant use of a surfactant or a dispersant such as colloidal silica.

However, there are limits to the degree of dispersion achievable by a method involving mechanical dispersion. As for adding a dispersant to improve the dispersibility of the inorganic substance in the base resin, this approach has the merit of being simple and convenient, but the addition of a dispersant may have undesirable effects, such as increasing the dielectric constant and lowering the heat resistance of the product.

In light of these problems, efforts are being made to modify the surface of inorganic substances so as to enhance their dispersibility in resins. One commonly used approach for modifying the surface of an inorganic substance involves coating the surface of the inorganic substance with an organic compound.

In this approach, adhesion of the organic compound to the surface of the inorganic substance is important. To increase such adhesion, use is made of methods which employ compounds, such as silane coupling agents, having a functional group capable of reacting with functional groups that are present on the surface of the inorganic substance or that have been introduced thereon by surface modification, and thereby administer a strong coat by means of chemical bonding (see Patent Document 1: JP-A 61-275359; Patent Document 2: JP-A 63-258958).

Yet, although a strong coat can easily be formed on the surface of the inorganic substance using these prior-art methods, the resulting inorganic substance lacks sufficient dispersibility in solvents and organic resins.

A number of attempts have been made recently to coat the surface of inorganic substances with a polymer layer so as to enhance the dispersibility of the inorganic substance in solvents and resins (see Patent Document 3: JP-A 57-102959; Patent Document 4: JP-A 5-295294; Patent Document 5: JP-A 5-295052).

However, in the surface-treated inorganic substances obtained by these methods, due to the low efficiency of graft polymerization and other reasons, the resulting polymer layer on the surface of the inorganic substance lacks an adequate thickness. As a result, the formation of a polymer layer on the surface has not been sufficiently effective in suppressing such characteristics inherent to inorganic substances as their high dielectric constant and their low acid resistance. That is, although the increase in dispersibility has enabled high loadings to be achieved, new problems such as decreased acid resistance and increased dielectric constant have arisen in the shaped articles obtained from such compositions. In the field of electronic materials, a high dielectric constant gives rise to the conduction of electricity, which is why a low dielectric constant is desired. A high acid resistance is an essential condition for carrying out etching treatment.

Patent Document 1: JP-A 61-275359

Patent Document 2: JP-A 63-258958

Patent Document 3: JP-A 57-102959

Patent Document 4: JP-A 5-295294

Patent Document 5: JP-A 5-295052

### DISCLOSURE OF THE INVENTION

### Problems to be Solved by the Invention

It is therefore an object of the invention to provide resin compositions which are capable of enhancing the dispersibility of modifiers such as inorganic substances, and which do not incur a decline in acid resistance with the addition of modifiers.

### Means for Solving the Problems

As a result of extensive investigations, we have discovered that base materials having a cyano group-bearing organic layer exhibit a good dispersibility in organic resins, enabling high loadings of inorganic substances and the like to be achieved in organic resins without the addition of dispersants such as surfactants. We have also found that the addition of a base material having a cyano group-bearing organic layer enables the acid resistance of the resulting composition to be greatly improved over that of compositions obtained by adding base materials having an organic layer that lacks cyano groups.

Accordingly, the invention provides the following resin compositions.
[1] A resin composition, characterized by comprising a base material having a cyano group-bearing organic layer, and an organic resin.
[2] The resin composition of [1] which is characterized in that the cyano group-bearing organic layer is composed of an organic substance having a cyano group equivalent weight per molecule of from 50 to 5,000.
[3] The resin composition of [1] or [2] which is characterized in that the base material has a cyano group-bearing organic layer in an amount of at least 0.3 wt % based on the base material.
[4] The resin composition of any one of [1] to [3] which is characterized in that the resin composition has a percent weight loss, when acid treated by 5 minutes of immersion in an aqueous solution containing 20 wt % of hydrogen chloride, which satisfies the following relationship with respect to the percent weight loss on similar acid treatment by an untreated base material-containing composition that includes, instead of the base material having a cyano group-bearing organic layer in the resin composition, a like amount (base material basis) of a base material lacking a cyano group-bearing organic layer: (percent weight loss of resin composition)/percent weight loss of untreated base material-containing composition)<0.10.
[5] The resin composition of any one of [1] to [4] which is characterized in that the cyano group-bearing organic layer is chemically bonded to the base material.
[6] The resin composition of any one of [1] to [5] which is characterized in that the base material is an inorganic substance.
[7] The resin composition of [6] which is characterized in that the inorganic substance is one or more selected from the group consisting of alkaline earth metal carbonates, alkaline earth metal silicates, alkaline earth metal phosphates, alkaline earth metal sulfates, metal oxides, metal hydroxides, metal silicates and metal carbonates.
[8] The resin composition of [7] which is characterized in that the inorganic substance is a metal hydroxide.
[9] The resin composition of [8] which is characterized in that the metal hydroxide is one or more selected from the group consisting of magnesium hydroxide, potassium hydroxide and calcium hydroxide.
[10] The resin composition of any one of [1] to [9] which is characterized in that the base material is composed of particles having an average particle size of 1 nm to 100 μm.
[11] The resin composition of any one of [1] to [10] which is characterized in that at least part of the cyano group-bearing organic layer is a layer derived from (meth)acrylonitrile.
[12] The resin composition of any one of [1] to [11] which is characterized in that the cyano group-bearing organic layer was formed in an ionic liquid-containing solvent.
[13] The resin composition of any one of [1] to [12] which is characterized in that the cyano group-bearing organic layer is a polymer layer.
[14] The resin composition of [13] which is characterized in that the polymer layer is a layer formed by graft polymerization.
[15] The resin composition of [13] or [14] which is characterized in that the polymer layer is a layer composed of a polymer having a number-average molecular weight of from 1,000 to 5,000,000.
[16] The resin composition of any one of [13] to [15] which is characterized in that the polymer layer has an average thickness of at least 1 nm.

### Effects of the Invention

Because the inventive composition is obtained by incorporating a base material having a cyano group-bearing organic layer into an organic resin, the base material has a good dispersibility in the organic resin. High loadings of the inorganic substance in the organic resin can thus be achieved without the addition of a surfactant or other dispersant, making it possible to avoid diminishing the physical characteristics of the composition, such as decreasing the heat resistance or increasing the dielectric constant, due to the addition of dispersant.

Moreover, because a base material having a cyano group-bearing organic layer is incorporated into an organic resin, the acid resistance of the composition can be greatly enhanced compared with the use of a base material having an organic layer lacking cyano groups.

Furthermore, if this cyano group-bearing organic layer is formed by graft polymerization, the thickness of the layer is increased, making it possible to effectively suppress the decrease in acid resistance hitherto associated with the addition of large amounts of modifiers such as inorganic substances to an organic resin.

### BEST MODE FOR CARRYING OUT THE INVENTION

The invention is described more fully below.

The resin composition according to the present invention is composed of a base material having a cyano group-bearing organic layer, and an organic resin.

The base material in the invention is not subject to any particular limitation, and may be either an organic substance or an inorganic substance.

The inorganic substance, while not subject to any particular limitation, is preferably a metal or metal compound which reacts with acids and undergoes dissolution with the release of hydrogen. Illustrative examples include alkaline earth metal carbonates such as calcium carbonate, barium carbonate, and magnesium carbonate; alkaline earth metal silicates such as calcium silicate, barium silicate and magnesium silicate; alkaline earth metal phosphates such as calcium phosphate, barium phosphate and magnesium phosphate; alkaline earth metal sulfates such as calcium sulfate, barium sulfate and magnesium sulfate; metal oxides such as silica, magnesium oxide, aluminum oxide, zinc oxide, iron oxide, titanium oxide, cobalt oxide, nickel oxide, manganese oxide, antimony oxide, tin oxide, calcium oxide and potassium oxide; metal hydroxides such as iron hydroxide, nickel hydroxide, aluminum hydroxide, calcium hydroxide, chromium hydroxide, potassium hydroxide and zinc hydroxide; metal silicates such as zinc silicate, aluminum silicate and copper silicate; and metal carbonates such as zinc carbonate, aluminum carbonate, cobalt carbonate, nickel carbonate and basic copper carbonate. Any one or combinations or two or more thereof may be used.

Of these, to impart to the inventive composition (or shaped articles obtained therefrom) a functionality suitable for use in such applications as electronics materials, coating materials and textile finishes, it is preferable to employ an inorganic oxide or hydroxide, such as silica, magnesium hydroxide, aluminum hydroxide, calcium hydroxide, potassium hydroxide, zinc hydroxide, magnesium oxide, aluminum oxide, zinc oxide, iron oxide, titanium oxide, cobalt oxide, nickel oxide, manganese oxide, calcium oxide or potassium oxide. Inorganic hydroxides such as magnesium hydroxide, calcium hydroxide or potassium hydroxide which are used as flame retardants in the above-mentioned areas because they exhibit a dehydrating effect under the application of heat are even more preferred.

The form of the inorganic substance varies depending on the use of the composition and thus cannot be strictly specified. However, in light of such considerations as the dispersibility of the inorganic substance in the composition, the moldability of the composition, and the fire retardance-enhancing effect which is proportionally related to the specific surface area (Kobunshi no nannen-ka gijutsu [Techniques for flame-retarding polymers] (published by CMC Publishing Co., Ltd.)), it is advantageous for the inorganic substance to be in the form of particles having an average particle size of 1 nm to 100 μm, preferably 10 nm to 50 μm, and more preferably 30 nm to 30 μm.

The organic substance, while not subject to any particular limitation, is exemplified by organic polymer particles composed of resins similar to the various resins mentioned later in the specification as examples of the subsequently described organic resins. It is desirable in this case for the particles to be spherical or substantially spherical particles having an average particle size of 1 nm to 100 μm, preferably 10 nm to 50 μm, and more preferably 30 nm to 30 μm.

The average particle size referred to above is a value measured with a particle size analyzer (9340-UPA150; manufactured by Nikkiso Co., Ltd.).

Formation of the organic layer on the surface of the base material may be carried out by forming the organic layer based on functional groups present on the base material itself, although it is preferable to modify the surface of the base material beforehand with a compound having reactive functional groups.

These reactive functional groups may be suitably selected according to the method of forming the organic layer. Illustrative examples include groups having polymerizable unsaturated bonds, such as α,β-unsaturated carbonyl groups, α,β-unsaturated cyano groups, vinyl halide groups, vinylidene halide groups, aromatic vinyl groups, heterocyclic vinyl groups, conjugated dienes, and vinyl carboxylate esters; and also carboxyl groups, carbonyl groups, epoxy groups, isocyanate groups, hydroxyl groups, amide groups, cyano groups, amino groups, epoxy groups, chloromethyl groups, glycidyl ether groups, lithio groups, ester groups, formyl groups, nitro groups, carbodiimide groups and oxazoline groups.

Any of various known methods may be employed to modify the base material with these compounds having reactive functional groups, although the use of a method that involves treating the base material with a surface treatment agent suitable for the functional group to be introduced is simple, and thus preferred.

Illustrative, non-limiting, examples of the surface treatment agent include unsaturated fatty acids, such as oleic acid; the metal salts of unsaturated fatty acids, such as sodium oleate, calcium oleate and potassium oleate; unsaturated fatty acid esters; unsaturated fatty acid ethers; surfactants; silane coupling agents, such as methacryloxymethyltrimethoxysilane, methacryloxypropyltrimethoxysilane, n-octadecylmethyldiethoxysilane, dodecyltrimethoxysilane, 2-(3,4-epoxycyclohexyl)ethyltrimethoxysilane, 2-(4-chlorosulfonyl)ethyltrimethoxysilane, triethoxysilane, vinyltrimethoxysilane and phenethyltrimethoxysilane; and titanate coupling agents.

In the practice of the invention, the cyano group equivalent weight per molecule of the organic substance making up the cyano group-bearing organic layer present on the surface of the base material is not subject to any particular limitation. However, to achieve a good acid resistance-enhancing effect in compositions containing this base material, the cyano group equivalent weight is preferably from about 50 to about 50,000. Depending on the application, the cyano group equivalent weight is more preferably from 55 to 1,500, even more preferably from 60 to 600, and most preferably from 100 to 300. It is even acceptable for the cyano groups to originate from an initiator. As used herein, “equivalent weight” refers to a fixed weight assigned for each compound based on the stoichiometric relationship of the substances which take part in a chemical reaction. For example, in this invention, “equivalent weight” represents the chemical formula weight of a molecule (in the case of a polymeric molecule, the average chemical formula weight) per mole of CN groups.

Also, it is preferable for the base material to have the cyano group-containing organic layer in an amount of at least 0.3 wt %, based on the base material. For good dispersibility and good acid resistance, the amount of cyano group-containing organic layer is more preferably at least 0.5 wt %, and most preferably at least 1.0 wt %. The weight percent (wt %) of the cyano group-bearing organic layer is a value calculated from the volume of the organic layer and the volume of the base material per cubic centimeter (cm³) of the base material having an organic layer, as determined based on density measurements taken with a gas pycnometer (Accupyc 1330, manufactured by Shimadzu Corporation; in helium).

The cyano group-bearing organic layer in the present invention is not subject to any particular limitation, provided it is a layer derived from an organic compound having a CN group. Illustrative examples includes layers derived from such compounds as (meth)acrylonitrile, hexenenitrile, 4-pentenenitrile, p-cyanostyrene, adiponitrile, 4-cyano-N-acetylphenylalanine, cyanoacetaldehyde dimethyl acetal, 4-cyanoaniline, 2-cyanoethanol-1-(cyanoethylaminoethyl)-2-methylimidazole, 1-cyanoethyl-2-undecylimidazole, 1-cyanoethyl-2-undecylimidazolium trimellitate, 1-cyanoethyl-2-ethyl-4-methylimidazole, 1-cyanoethyl-2-ethyl-4-methylimidazolium trimellitate, 1-cyanoethyl-2-phenylimidazole, 1-cyanoethyl-2-phenylimidazolium trimellitate, 1-cyanoethyl-2-methylimidazole, 1-cyanoethyl-2-methylimidazolium trimellitate, cyanoguanidine, cyanocobalamin, cyanoacetic acid, ethyl cyanoacetate, methyl cyanoacetate, α-cyanotoluene, 2-cyano-4-nitroaniline, 4-cyano-4′-hydroxybiphenyl, 4′-cyanobiphenyl-4-ol, 2-cyanopyrazine, cyanopyridine, p-cyanophenylalanine and cyanopropionaldehyde dimethyl acetal. For low cost and good reactivity, it is preferable that at least part of the cyano group-bearing organic layer be a layer derived from (meth)acrylonitrile.

As used herein, the expression “layer derived from” encompasses both low-molecular-weight organic compound layers composed of the various above-mentioned low-molecular-weight compounds, and polymer layers obtained by homopolymerization of the various above-mentioned low-molecular-weight compounds or copolymerization between different cyano group-bearing organic compounds or with other polymerizable monomers. In the practice of the invention, it is also possible to use a polymer layer which forms a crosslinked structure at the surface of the base material.

Hence, the cyano group-bearing organic layer may be a layer composed of a low-molecular-weight compound or a layer composed of a high-molecular-weight (polymeric) compound. However, to further increase the dispersibility of the base material within the organic resin and the acid resistance of the inventive composition, it is preferable for the cyano group-bearing organic layer to be a polymer layer composed of a high-molecular-weight compound.

The polymeric compound making up the polymer layer has a number-average molecular weight (Mn) which varies according to the thickness of the polymer layer and the grafting density, and thus cannot be strictly specified. Nevertheless, the number-average molecular weight is typically from 1,000 to 5,000,000, preferably from 2,500 to 4,500,000, more preferably from 5,000 to 3,000,000, and even more preferably from 10,000 to 1,000,000. The number-average molecular weight is a measured value obtained by gel filtration chromatography.

When a polymer layer is used as the organic layer, the thickness of the layer is not subject to any particular limitation. However, to impart the composition and shaped articles made therefrom with a sufficient acid resistance, it is desirable for the average thickness to be preferably at least 1 nm, more preferably at least 2 nm, and even more preferably at least 3 nm. The thickness of the polymer layer is a value calculated from the volume of the polymer layer, the volume of the base material and the total surface area per cubic centimeter (cm³) of the base material having a polymer layer, all of which are determined based on density measurements taken with a gas pycnometer (Accupyc 1330, manufactured by Shimadzu Corporation; in helium).

In the practice of the invention, the cyano group-bearing organic compound may be rendered into an organic layer by bonding functional groups present on the base material itself, or the above-mentioned reactive functional groups introduced onto the base material, with chemical bonds such as covalent bonds, hydrogen bonds or coordinate bonds, or with physical bonds. The reaction of the base material with the organic compound may be suitably selected from among known techniques according to the type of bond.

Exemplary methods for coating the surface of the base material with a polymer layer that may be used in the practice of the invention include in particular a method involving the use of a spray dryer, seed polymerization, adsorption of the polymer onto the base material, and a graft polymerization process that chemically bonds the polymer with particles of the base material. Of these, the use of graft polymerization is preferred for a number of reasons, including: (A) the ability to form an organic layer which is relatively thick and does not readily dissolve out into the surrounding solvent even during long-term dispersion of the polymer layer-bearing base material in a solvent, (B) the ability to confer diverse surface properties by varying the type of monomer, and (C) grafting at a high density is possible by carrying out polymerization based on polymerization initiating groups introduced onto the surface of the base material.

The process of forming a polymer layer with grafted chains is exemplified here by a method in which the grafted chains are prepared beforehand by polymerization, then are chemically bonded to the surface of the base material, and a method in which graft polymerization is carried out on the surface of the base material. Although either method may be used, the latter approach, which is less subject to adverse effects such as steric hindrance, is preferable for increasing the density of the grafted chains at the surface of the base material.

Illustrative examples of the chemical bonds between the base material and the grafted chains include covalent bonds, hydrogen bonds, and coordinate bonds.

Examples of graft polymerization reactions include addition polymerization reactions such as free-radical polymerization, ionic polymerization, oxidative anionic polymerization and ring-opening polymerization; polycondensation reactions such as elimination polymerization, dehydrogenation polymerization, and denitrogenation polymerization; hydrogen transfer polymerization reactions such as addition polymerization, isomerization polymerization, and group transfer polymerization; and addition condensation. Of these, free-radical polymerization is especially preferred because it is simple and highly cost-effective, and is commonly used for the industrial synthesis of various polymers. Where there is a need to control the molecular weight of the grafted chains, the molecular weight distribution or the grafting density, use can be made of living radical polymerization.

Living radical polymerization is broadly divided into three types, any of which may be used in the present invention: (i) a dissociation-bonding mechanism in which polymerization proceeds by activation involving the use of typically heat or light to reversibly cleave the covalent bond on a dormant species P—X so that it dissociates to a P radical and an X radical; (ii) atom transfer radical polymerization (ATRP), which proceeds by the activation of P—X under the action of a transition metal complex; and (iii) an exchange chain transfer mechanism in which polymerization proceeds by P—X triggering an exchange reaction with another radical.

When carrying out graft polymerization, the cyano group-bearing organic compound may be copolymerized with another graft polymerizable monomer. The graft polymerizable monomer is not subject to any particular limitation, provided it is a compound having functional groups capable of reacting in graft polymerization.

For example, when a radical polymerization reaction is employed, use can be made of any one or combination of two or more of the following reactive unsaturated bond (double bond)-bearing monomers: styrene compounds such as styrene, o-methylstyrene, m-methylstyrene, p-methylstyrene, α-methylstyrene, p-ethylstyrene, 2,4-dimethylstyrene, p-n-butylstyrene, p-t-butylstyrene, p-n-hexylstyrene, p-n-octylstyrene, p-n-nonylstyrene, p-n-decylstyrene, p-n-dodecylstyrene, p-methoxystyrene, p-phenylstyrene, p-chlorostyrene and 3,4-dichlorostyrene; (meth)acrylic acid esters such as methyl acrylate, ethyl acrylate, n-butyl acrylate, isobutyl acrylate, propyl acrylate, hexyl acrylate, 2-ethylhexyl acrylate, n-octyl acrylate, dodecyl acrylate, lauryl acrylate, stearyl acrylate, 2-chloroethyl acrylate, phenyl acrylate, methyl α-chloroacrylate, methyl methacrylate, ethyl methacrylate, n-butyl methacrylate, isobutyl methacrylate, propyl methacrylate, hexyl methacrylate, 2-ethylhexyl methacrylate, n-octyl methacrylate, dodecyl methacrylate, lauryl methacrylate and stearyl methacrylate; vinyl carboxylates such as vinyl acetate, vinyl propionate, vinyl benzoate and vinyl butyrate; vinyl ethers such as vinyl methyl ether, vinyl ethyl ether and vinyl isobutyl ether; vinyl ketones such as vinyl methyl ketone, vinyl hexyl ketone and methyl isopropenyl ketone; N-vinyl compounds such as N-vinylpyrrole, N-vinylcarbazole, N-vinylindole and N-vinylpyrrolidone; compounds having fluoroalkyl groups, such as vinyl fluoride, vinylidene fluoride, tetrafluoroethylene, hexafluoropropylene, trifluoroethyl acrylate and tetrafluoropropylene acrylate. Of these, from the standpoint of monomer reactivity, the use of a vinyl group-based and/or (meth)acryl group-based monomer, copolymer or polymer is preferred.

When radical polymerization is employed, it is also possible to prepare a polymer having a crosslinked structure using a monomer with two or more reactive unsaturated bonds (double bonds). Illustrative, non-limiting, examples of such monomers include aromatic divinyl compounds such as divinylbenzene and divinylnaphthalene; and compounds such as ethylene glycol diacrylate, ethylene glycol dimethacrylate, triethylene glycol dimethacrylate, tetraethylene glycol dimethacrylate, 1,3-butylene glycol dimethacrylate, trimethylolpropane triacrylate, trimethylolpropane trimethacrylate, 1,4-butanediol diacrylate, neopentyl glycol diacrylate, 1,6-hexanediol diacrylate, pentaerythritol triacrylate, pentaerythritol tetraacrylate, pentaerythritol dimethacrylate, pentaerythritol tetramethacrylate, glycerol acryloxy dimethacrylate, N,N-divinyl aniline, divinyl ether, divinyl sulfide and divinyl sulfone. These may be used singly or as combinations of two or more thereof. Of the above, the use of a vinyl group-based and/or (meth)acryl group-based monomer or copolymer is preferred.

Any of various known polymerization initiators may be used when carrying out radical polymerization. Illustrative examples include benzoyl peroxide, cumene hydroperoxide, t-butyl hydroperoxide, persulfates such as sodium persulfate, potassium persulfate and ammonium persulfate, and azo compounds such as azobisisobutyronitrile, azobismethylbutyronitrile and azobisisovaleronitrile. These may be used singly or as combinations of any two or more thereof.

When a polymerization process other than free radical polymerization is employed, illustrative, non-limiting, examples of compounds which may be used together with the cyano group-bearing organic compound include carboxylic acids and carboxylic acid derivatives, such as formic acid, acetic acid, propionic acid, butyric acid, valeric acid, oxalic acid, malonic acid, succinic acid, glutaric acid, adipic acid, pimelic acid, maleic acid, fumaric acid, phthalic acid, isophthalic acid, terephthalic acid, acetyl chloride and benzoyl chloride; inorganic acids and inorganic bases such as sulfuric acid, phosphoric acid, sodium hydroxide and potassium hydroxide; alcohols such as methanol, ethanol, phenol, methylphenol, nitrophenol, picric acid, ethylene glycol and glycerol; halogenated organic compounds such as ethyl bromide, (S)-3-bromo-3-methylhexane and chloromethane; amine compounds such as ethylamine, aminoethane, 2-aminopentane, 3-aminobutanoic acid, aniline, p-bromoaniline, cyclohexylamine, ammonia, acetamide, p-toluidine and p-nitrotoluene; and formaldehyde. Use may also be made of copolymers or polymers composed of one or more of these compounds.

The graft polymerization conditions are not subject to any particular limitation. Various known conditions may be employed according to such considerations as the monomer being used.

For example, when grafting is effected by carrying out free radical polymerization on the surface of the base material, the quantity of polymerizable monomer, including the cyano group-bearing organic compound, used per 0.1 mol of reactive functional groups introduced onto the base material is generally from 1 to 300 mol, and the quantity of polymerization initiator used is generally from 0.005 to 30 mol. The polymerization temperature is generally from −20 to 1,000° C., and the polymerization time is generally from 0.2 to 72 hours.

When graft polymerization is carried out, various additives such as dispersants, stabilizers and emulsifying agents (surfactants) may be optionally added to the polymerization reaction system.

The polymer layer formed by graft polymerization, aside from being formed by grafting on the surface of the base material in the manner just described, may alternatively be formed, as noted above, by reacting an already prepared polymer with reactive functional groups on the surface of the base material.

Illustrative examples of methods that may be used to react the base material with the polymer in such a case include a dehydration reaction, a nucleophilic substitution reaction, an electrophilic substitution reaction, an electrophilic addition reaction, and an adsorption reaction.

Solvents that may be used in the polymerization reaction are not subject to any particular limitation, and may be selected as appropriate from among the various types of solvents employed in general polymer synthesis. Illustrative examples include water; alcohols such as methanol, ethanol, 1-propanol, 2-propanol, 1-butanol, 2-butanol, i-butyl alcohol, t-butyl alcohol, 1-pentanol, 2-pentanol, 3-pentanol, 2-methyl-1-butanol, i-pentyl alcohol, t-pentyl alcohol, 1-hexanol, 2-methyl-1-pentanol, 4-methyl-2-pentanol, 2-ethylbutanol, 1-heptanol, 2-heptanol, 3-heptanol, 2-octanol, 2-ethyl-1-hexanol, benzyl alcohol and cyclohexanol; ether alcohols such as methyl cellosolve, ethyl cellosolve, isopropyl cellosolve, butyl cellosolve and diethylene glycol monobutyl ether; ketones such as acetone, methyl ethyl ketone, methyl isobutyl ketone and cyclohexanone; esters such as ethyl acetate, butyl acetate, ethyl propionate and cellosolve acetate; aliphatic or aromatic hydrocarbons such as pentane, 2-methylbutane, heptane, n-hexane, 2-methylpentane, 2,2-dimethylbutane, 2,3-dimethylbutane, heptane, n-octane, isooctane, 2,2,3-trimethylpentane, nonane, decane, cyclopentane, methyl cyclopentane, cyclohexane, methyl cyclohexane, ethyl cyclohexane, p-menthane, dicyclohexyl, benzene, toluene, xylene, ethylbenzene and anisole (methoxybenzene); halogenated hydrocarbons such as carbon tetrachloride, trichloroethylene, chlorobenzene and tetrabromoethane; ethers such as diethyl ether, dimethyl ether, trioxane and tetrahydrofuran; acetals such as methylal and diethylacetal; aliphatic acids such as formic acid, acetic acid and propionic acid; and sulfur or nitrogen-bearing organic compounds such as nitropropane, nitrobenzene, dimethylamine, monoethanolamine, pyridine, dimethylformamide, dimethylsulfoxide and acetonitrile. Any one or combinations of two or more thereof may be used.

Of these solvents, the use of the oil-soluble and water-soluble solvents dimethylformamide, tetrahydrofuran and n-methyl-2-pyrrolidone is preferred because of their good ability to disperse the base material prior to treatment and the high solubility therein of polymerized graft polymers, and also because these solvents enable the polymerization of high-molecular-weight graft polymers.

An ionic liquid may be used as a reaction solvent when the cyano group-bearing organic layer is formed on the surface of the base material. In this case, the method used may be either a process involving the reaction, within the ionic liquid, of the base material with the low-molecular-weight compound or polymeric organic compound that forms the cyano group-bearing organic layer, or a process in which the polymerization reaction at the surface of the base material is carried out in an ionic liquid.

By using an ionic liquid as the reaction solvent, the production time can be shortened and the amount of organic solvent used can be held to a very low level or eliminated altogether. Also, the ionic liquid can be re-used, thus making it possible to increase the environmental compatibility and safety. In addition, by carrying out the above-described polymerization reaction in an ionic liquid, the thickness of the cyano group-bearing organic layer can be further improved and a resin composition having an even better acid resistance can be obtained. “Ionic liquid” is used herein as a generic term for liquid salts, particularly salts which are liquid near room temperature. An ionic liquid is a solvent composed entirely of ions.

The ionic liquid in the present invention is not subject to any particular limitation, although it is preferable for the cation in the ionic liquid to be at least one selected from among ammonium cations, imidazolium cations and pyridinium cations. Of these, ammonium cations are especially preferred.

Imidazolium cations, while not subject to any particular limitation, are exemplified by dialkylimidazolium cations and trialkylimidazolium cations. Specific examples include the 1-ethyl-3-methylimidazolium ion, the 1-butyl-3-methylimidazolium ion, the 1,2,3-trimethylimidazolium ion, the 1,2-dimethyl-3-ethylimidazolium ion, the 1,2-dimethyl-3-propylimidazolium ion, and the 1-butyl-2,3-dimethylimidazolium ion.

Pyridinium cations, while not subject to any particular limitation, are exemplified by the N-propylpyridinium ion, the N-butylpyridinium ion, the 1-butyl-4-methylpyridinium ion and the 1-butyl-2,4-dimethylpyridinium ion.

Ammonium cations, while not subject to any particular limitation, are exemplified by aliphatic or alicyclic quaternary ammonium ions as the cation component.

Illustrative, non-limiting, examples of these aliphatic or alicyclic quaternary ammonium ions include such quaternary alkyl ammonium ions as the trimethylpropylammonium ion, the trimethylhexylammonium ion and the tetrapentylammonium ion; and the N-butyl-N-methylpyrrolidinium ion. The use of an aliphatic or alicyclic quaternary ammonium ion having the following general formula (1) is especially preferred. 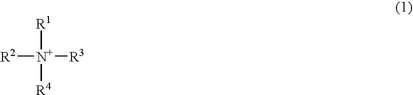
In the formula, R¹ to R⁴ are each independently an alkyl group of 1 to 5 carbons or an alkoxyalkyl group of the formula R′—O—(CH₂)ₙ— (R′ being methyl or ethyl, and the letter n being an integer from 1 to 4), and any two from among R¹, R², R³ and R⁴ may together form a ring. At least one of R¹ to R⁴ must be an alkoxyalkyl group of the above description.

In formula (1), examples of the alkyl group of 1 to 5 carbons include methyl, ethyl, propyl, 2-propyl, butyl and pentyl. The viscosity of the ionic liquid tends to increase at a higher molecular weight. Because use as a solvent becomes more difficult at a higher viscosity, it is preferable for at least one of R¹ to R⁴ to be methyl, ethyl or propyl, and especially methyl or ethyl.

Examples of alkoxyalkyl groups of the formula R′—O—(CH₂)ₙ— include methoxymethyl, ethoxymethyl, methoxyethyl, ethoxyethyl, methoxypropyl, ethoxypropyl, methoxybutyl and ethoxybutyl. As noted above, the letter n is an integer from 1 to 4. However, for a high ionic liquid-forming ability, n is preferably 1 or 2, and most preferably 2.

Exemplary cations in which any two of R¹ to R⁴ together form a ring include quaternary ammonium ions having an aziridine ring, an azetidine ring, a pyrrolidine ring or a piperidine ring.

Of the quaternary ammonium ions represented by above formula (1), for reasons having to do with the high ionic liquid-forming ability, the low cost of the starting materials, and the ability of the ionic liquid to be synthesized by a relatively simple method, quaternary ammonium ions having an alkoxyethyl group of formula (2) below are preferred, and quaternary ammonium ions of formula (3) below are even more preferred. 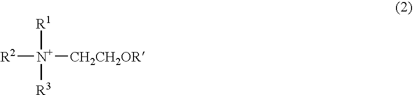
In formula (2), R¹ to R³ and R′ are the same as above. 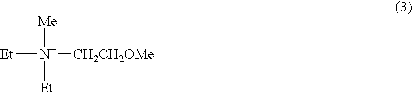
In formula (3), “Me” stands for methyl, and “Et” stands for ethyl.

Like the quaternary ammonium ions of above formula (3), ammonium cations having a 2-alkoxyethyl group readily exhibit the properties of an ionic liquid. For example, the ammonium cations of formulas (4) to (6) below exhibit the properties of an ionic liquid. These too are advantageous for use.

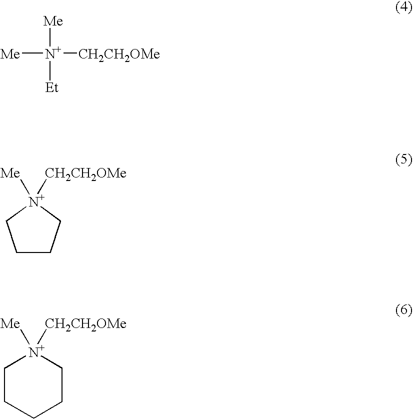

Illustrative, non-limiting, examples of the above-described anions in the ionic liquid include BF₄⁻, PF₆³¹ , AsF₆⁻, SbF₆⁻, AlCl₄⁻, HSO₄⁻, ClO₄⁻, CH₃SO₃⁻, CF₃SO₃⁻, CF₃CO₂⁻, (CF₃SO₂)₂N⁻, Cl⁻, Br⁻ and I⁻.

In the practice of the invention, the ionic liquid may be used alone, or may be used in admixture with any of various solvents that are conventionally used, such as those mentioned above as polymerization reaction solvents.

When the ionic liquid is used in admixture with a conventional solvent, at a content of the ionic liquid within the mixed solvent of about 5 wt %, for example, the reactivity between the reactive functional groups on the base material and the functional groups on the compound which reacted therewith increases. Also, in a polymerization reaction, the molecular weight and molecular weight distribution of the grafted chains or blocked chains on the resulting polymer are easier to control. However, for such reasons as the ease of post-treatment, environmental compatibility and safety, it is desirable for the concentration of the ionic liquid in the mixed solvent to be at least 10 wt %, more preferably at least 50 wt %, and most preferably from 80 to 100 wt %.

Illustrative, non-limiting, examples of the organic resin in the resin composition of the invention include thermoplastic resins such as polyolefin resins (e.g., polyethylene, polypropylene), polystyrene resins (e.g., polystyrene), polyvinyl halide derivative resins (e.g., polyvinyl chloride, polyvinylidene chloride), polyvinyl acetate derivative resins (e.g., polyvinyl acetate), poly(meth)acrylic resins (e.g., polymethyl methacrylate), polyvinyl ethers (e.g., polyvinyl methyl ether, polyvinyl ethyl ether, polyvinyl isobutyl ether), polyvinyl ketones (e.g., polyvinyl methyl ketone, polyvinyl hexyl ketone, polymethyl isopropenyl ketone), poly(N-vinyl compounds) (e.g., poly(N-vinylpyrrole), poly(N-vinylcarbazole), poly(N-vinylindole), poly(N-vinylpyrrolidone)), fluoropolymers, polyamides (e.g., nylon 6), polyesters, polycarbonates, silicones, polyacetals, and acetyl cellulose; and thermoset resins such as epoxy resins, phenol resins, urea resins, melamine resins, alkyd resins, and unsaturated polyester resins.

Of these, from the standpoint of such considerations as environmental compatibility and the diversity of uses for the composition, the use of polystyrene resins, polyolefin resins, poly(meth)acrylic resins, vinyl carboxylate resins such as polyvinyl acetate, and epoxy resins is preferred.

No particular limitation is imposed on the compounding ratio between the base material having a cyano group-bearing organic layer and the organic resin. However, to achieve a good balance between the various functionality-enhancing effects and the decrease in physical properties owing to incorporation of the base material, the weight ratio of the base material having an organic layer (untreated base material basis) to the organic resin is preferably from 1:99 to 90:10, more preferably from 10:90 to 80:20, and even more preferably from 30:70 to 70:30.

Moreover, it is preferable for the resin composition of the invention to have characteristic (1) described below. As used herein, “composition” encompasses both compositions of a mixed indefinite form obtained by merely mixing the base material and the organic resin, and also shaped articles obtained by shaping such compositions.
(1) The resin composition has a percent weight loss, when acid treated by 5 minutes of immersion in an aqueous solution containing 20 wt % of hydrogen chloride, which satisfies the following relationship with respect to the percent weight loss on similar acid treatment by an untreated base material-containing composition that includes, instead of the base material having a cyano group-bearing organic layer in the resin composition, a like amount (base material basis) of a base material lacking a cyano group-bearing organic layer: (percent weight loss of resin composition)/(percent weight loss of untreated base material-containing composition)<0.10, preferably <0.05, and more preferably <0.03.

At a percent weight loss ratio of 0.10 or more, the composition is likely to undergo a color change when acid treated.

Aside from the size of the test specimen, the hydrochloric acid concentration and the duration of the test, the above test procedure is carried out in accordance with the test method described in JIS K7114. The percent weight loss is determined based on the weight of the composition following acid treatment, thorough washing with water, and drying.

The above-described resin composition of the invention, owing to the inclusion therein of a base material having a cyano group-bearing organic layer, has an excellent acid resistance.

Moreover, because of the good compatibility between the base material having a cyano group-bearing organic layer and the organic resin, uniform loading of the base material in the organic resin can be achieved without the addition of a surfactant or other dispersant. As a result, high loadings of the base material are possible, and new functionalities representing a combination of the distinctive characteristics of the base material and the distinctive characteristics of the organic substance can be effectively achieved.

This resin composition has a variety of applications, depending on the type of base material, the type of organic layer and the type of organic resin. For example, it can be advantageously used as materials requiring various types of functionality in such areas of application as electronics materials, building materials, automotive materials, and textile modifiers.

### EXAMPLES

The invention is illustrated more fully through the following Synthesis Examples, Examples of the invention, and Comparative Examples. It is to be understood that the examples provided below are not intended to limit the invention.

[Synthesis of Ionic Liquid]

### Synthesis Example 1

### Synthesis of Bis(trifluoromethanesulfonimide) Salt of Diethylmethyl(2-methoxyethyl)ammonium (Abbreviated Below as “DEME·TFSI”)

A solution was prepared by mixing together 100 mL of diethylamine (available from Kanto Chemical Co., Inc.) and 85 mL of 2-methoxyethyl chloride (Kanto Chemical), following which the solution was placed in an autoclave and reacted at 100° C. for 24 hours. The pressure within the autoclave at this time was 0.127 MPa (1.3 kgf/cm²). After 24 hours, 200 ml of an aqueous solution containing 56 g of dissolved potassium hydroxide (Katayama Chemical Industries Co., Ltd.) was added to the resulting mixture of precipitated crystals and reaction solution, and the two organic phases that formed were separated off with a separatory funnel. In addition, the addition of 100 mL of methylene chloride (Wako Pure Chemical Industries, Ltd.) and extraction were carried out twice.

The organic phases that had been separated off were combined, washed with saturated saline, then dried over potassium carbonate (Wako Pure Chemical Industries) and vacuum filtered. The solvent was driven from the organic phase with a rotary evaporator, following which the residue was subjected to atmospheric pressure distillation, yielding 18.9 g of a fraction which boiled at close to 135° C. This compound was confirmed by ¹H-NMR spectroscopy to be 2-methoxyethyldiethylamine.

Next, 8.24 g of the 2-methoxyethyldiethylamine was dissolved in 10 mL of tetrahydrofuran (Wako Pure Chemical Industries), then 4.0 mL of methyl iodide (Wako Pure Chemical Industries) was added under ice cooling. After 30 minutes, the ice bath was removed and the mixture was stirred overnight at room temperature. The solvent in this reaction mixture was removed by vacuum distillation, and the resulting solids were recrystallized from an ethanol (Wako Pure Chemical Industries)—tetrahydrofuran system, yielding 16 g of 2-methoxyethyldiethylmethylammonium iodide.

Next, 10.0 g of the 2-methoxyethyldiethylmethylammonium iodide was dissolved in 50 mL of acetonitrile (Kanto Chemical). Lithium bis(trifluoromethanesulfonyl)imide, 9.5 g, (Kishida Chemical Co., Ltd.) was then added to the solution and completely dissolved therein, after which the solution was stirred for 15 minutes.

The acetonitrile was subsequently removed by vacuum distillation, and water was added to the residue. The organic phase that divided in two was separated off, then washed five times with water to remove impurities.

After washing, the organic phase was placed under a reduced pressure using a vacuum pump and the water was thoroughly driven off, yielding 6.8 g of DEME·TFSI, which is liquid at room temperature. This procedure was carried out a plurality of times to synthesize the required amount of product.

### Synthesis Example 2

### Synthesis of Tetrafluoroborate Salt of Diethylmethyl(2-methoxyethyl)ammonium (Abbreviated Below as “DEME·BF₄”)

First, 15.0 g of 2-methoxyethyldiethylmethyl ammonium iodide synthesized in the same way as in Synthesis Example 1 was dissolved in 100 mL of distilled water, after which 6.37 g of silver oxide (Kanto Chemical) was added and the mixture was stirred for 3 hours. This reaction mixture was vacuum filtered to remove precipitate, following which 42% tetrafluoroboric acid (Kanto Chemical) was added a little at a time under stirring until the reaction solution reached a pH of about 5 to 6. The reaction solution was then freeze-dried and water was thoroughly driven off with a vacuum pump, yielding 12.39 g of DEME·BF₄, which is liquid at room temperature. This procedure was carried out a plurality of times to synthesize the required amount of product.

### Synthesis Example 3

### Synthesis of Bis(trifluoromethanesulfonylimide) Salt of N-(2-methoxyethyl)-N-methylpyrrolidinium (Abbreviated Below as “ProMe·TFSI”)

Aside from using pyrrolidine instead of diethylamine and setting the reaction temperature in the autoclave at 90° C., ProMe·TFSI was synthesized in the same way as in Synthesis Example 1. This procedure was carried out a plurality of times to synthesize the required amount of product.

[Examples of the Synthesis of Inorganic Substance Particles Having a Cyano Group-Bearing Organic Layer]

### Synthesis Example 4

First, 20.0 g of Mg(OH)₂ having an average particle size of 700 nm (Kisuma 5Q, non-surface treated Mg(OH)₂ produced by Kyowa Chemical Industry Co., Ltd.) was thoroughly dispersed in 30.0 g of dimethylformamide (available from Sigma-Aldrich Japan K. K.; abbreviated below as “DMF”) in a 100 ml round-bottomed flask. Next, 0.1 g of 3-methacryloxypropyltrimethoxysilane (a silane coupling agent produced by Chisso Corporation) was added, and the flask contents were stirred at 70° C. for 30 minutes. Then, 0.08 g of azobisisobutyronitrile (Kanto Chemical; abbreviated below as “AIBN”), 14.0 g of styrene and 6.0 g of acrylonitrile (Kanto Chemical) were added, and reacted for about 30 hours under heating at 70° C. The theoretical CN group equivalent weight per molecule (chemical formula weight per molecule), which is an average because the molecules here are polymeric, was about 177.

Following reaction completion, to remove unreacted monomer and ungrafted polymer, the Mg(OH) particles were washed with tetrahydrofuran (Wako Pure Chemical Industries; abbreviated below as “THF”) and suction filtered four times. After washing, the IR spectrum of these particles was measured with an FT-IR8900 spectrometer, whereupon benzene ring absorption near 700 cm⁻¹ and acrylonitrile absorption near 2200 cm⁻¹ appeared, confirming that the styrene and acrylonitrile had grafted.

The average particle size indicated above was measured with a particle size analyzer (9340-UPA150; manufactured by Nikkiso Co., Ltd.).

### Synthesis Example 5

Aside from changing the polymerization solvent to the DEME·TFSI synthesized in Synthesis Example 1 and changing the polymerization time to 1.5 hours, grafted Mg(OH)₂ was synthesized by the same method as in Synthesis Example 2. As in Synthesis Example 2, the theoretical CN group equivalent weight per molecule (chemical formula weight per molecule), which is an average because the molecules here are polymeric, was about 177.

### Synthesis Example 6

Aside from changing the polymerization solvent to the DEME·BF₄ synthesized in Synthesis Example 1 and changing the polymerization time to 1.5 hours, grafted Mg(OH)₂ was synthesized by the same method as in Synthesis Example 2. As in Synthesis Example 2, the theoretical CN group equivalent weight per molecule (chemical formula weight per molecule), which is an average because the molecules here are polymeric, was about 177.

### Synthesis Example 7

Aside from changing the polymerization solvent to the ProMe·TFSI synthesized in Synthesis Example 2 and changing the polymerization time to 1.5 hours, grafted Mg(OH)₂ was synthesized by the same method as in Synthesis Example 2. As in Synthesis Example 2, the theoretical CN group equivalent weight per molecule (chemical formula weight per molecule), which is an average because the molecules here are polymeric, was about 177.

### Synthesis Example 8

Aside from changing the polymerization solvent to 1-ethyl-3-methylimidazolium tetrafluoroborate (abbreviated below as “EMI·BF₄∞; an ionic liquid produced by Tokyo Chemical Industry Co., Ltd.) and changing the polymerization time to 1.5 hours, grafted Mg(OH)₂ was synthesized by the same method as in Synthesis Example 2. As in Synthesis Example 2, the theoretical CN group equivalent weight per molecule (chemical formula weight per molecule), which is an average because the molecules here are polymeric, was about 177.

### Synthesis Example 9

Aside from changing the cyano group-bearing monomer from acrylonitrile to cyanostyrene and changing the amount to 14.6 g so as to give a theoretical CN group equivalent weight (chemical formula weight per molecule) of about 177 as in Synthesis Example 2, grafted Mg(OH)₂ was synthesized by the same method as in Synthesis Example 2.

### Synthesis Example 10

Aside from changing the inorganic substance from Mg(OH)₂ to ZnO (NanoTek, produced by C. I. Kasei, Ltd.; average particle size, 0.03 μm), grafted ZnO was synthesized by the same method as in Synthesis Example 2. As in Synthesis Example 2, the theoretical CN group equivalent weight per molecule (chemical formula weight per molecule), which is an average because the molecules here are polymeric, was about 177.

### Synthesis Example 11

First, 20.0 g of the above-described ZnO was thoroughly dispersed in 30.0 g of dimethylformamide (Aldrich Japan; abbreviated below as “DMF”) within a 100 ml round-bottomed flask. Next, 0.1 g of 3-methacryloxypropyl-trimethoxysilane (a silane coupling agent produced by Chisso Corporation) was added, and the flask contents were stirred at 70° C. for 30 minutes, thereby synthesizing ZnO particles that were surface-treated with a coupling agent.

The Mg(OH)₂ particles and ZnO particles grafted in Synthesis Examples 4 to 10 were subjected to cleavage, by the method described below, of the ester groups linking the graft polymer and the Mg(OH)₂, following which the molecular weight and molecular weight distribution of the graft polymer were measured.

In each case, 1.0 g of the grafted Mg(OH)₂ particles was dispersed in a mixed solution of 2 ml of distilled water, 12 ml of THF and 5 ml of ethanol (Kanto Chemical) within a 100 ml beaker, following which 0.22 g of potassium hydroxide (Sigma-Aldrich Japan) was added and the reaction was carried out at 55° C. for 7 hours.

The molecular weight and molecular weight distribution of the graft polymer were similarly determined for the grafted ZnO particles as well.

Following the reaction, the reaction solution was neutralized with hydrochloric acid (Wako Pure Chemical Industries), and the Mg(OH)₂ particles were removed. The solution remaining after removal of the particles was concentrated, and the solids obtained (graft polymer) were washed with water, hexane (Wako Pure Chemical Industries) and methanol (Wako Pure Chemical Industries).

The molecular weight of the washed grafted polymer was measured by gel filtration chromatography (GPC) using the following apparatus and conditions.

Molecular Weight Measurement Conditions

GPC apparatus: C-R7A, manufactured by Shimadzu Corporation Detector: UV spectrophotometer detector (SPD-6A), manufactured by Shimadzu Corporation
Pump: Molecular weight distribution measurement system pump (LC-6AD), manufactured by Shimadzu Corporation
Columns: A total of three columns connected in series; two Shodex KF804L (Showa Denko K. K.) columns and one Shodex KF806 (Showa Denko)
Solvent: Tetrahydrofuran
Measurement temperature: 40° C.

The thickness of the polymer layer on the surface of the particles obtained in each of Synthesis Examples 4 to 10 was determined in the manner described below. The thickness of the organic layer on the Mg(OH)₂ particles (Kisuma 5A, produced by Kyowa Chemical Industry Co., Ltd.) surface treated with the organic substance used in each of the subsequently described examples of the invention was also determined. Those results as well are shown in Table 1.

Method of Measuring Thickness of Polymer Layer

The densities of the respective particles obtained in Synthesis Examples 4 to 10 were determined using a gas pycnometer (Accupyc 1330, manufactured by Shimadzu Corporation; in helium). Based on these results and the densities of Mg(OH)₂ and ZnO prior to grafting, the volume of the polymer layer, the volume of the inorganic substance and the total surface area per cubic centimeter (cm³) of the polymer grafted inorganic substance were determined. The thickness of the polymer layer was calculated from these values. The volume and total surface area were determined while assuming the Mg(OH)₂ and ZnO at this time to be spherical.

TABLE 1

| | | | Thickness |
|---|---|---|---|
| | Mn | Mw | (nm) |
| Synthesis Example 4 | 13,000 | 35,000 | 3.5 |
| Synthesis Example 5 | 650,000 | 1,500,000 | 15 |
| Synthesis Example 6 | 720,000 | 1,550,000 | 16 |
| Synthesis Example 7 | 600,000 | 1,350,000 | 14 |
| Synthesis Example 8 | 580,000 | 1,280,000 | 13 |
| Synthesis Example 9 | 15,000 | 37,000 | 3.8 |
| Synthesis Example 10 | 12,000 | 30,000 | 3.3 |
| Synthesis Example 11 | — | — | 0* |
| Kisuma 5A | — | — | 0* |

Note:
In Table 1, “0*” signifies that, based on calculations, the thickness is substantially 0 nm.

[Preparation of Resin Compositions (Shaped Articles)]

### Examples 1 to 7, and Comparative Examples 1 to 4

In these examples, a dispersion prepared by dispersing, respectively, 4.56 g of the Mg(OH)₂ particles that were polymer grafted in Synthesis Example 4 (Example 1), 4.73 g of the Mg(OH)₂ particles that were polymer grafted in Synthesis Example 5 (Example 2), 4.74 g of the Mg(OH)₂ particles that were polymer grafted in Synthesis Example 6 (Example 3), 4.69 g of the Mg(OH)₂ particles that were polymer grafted in Synthesis Example 7 (Example 4), 4.68 g of the Mg(OH)₂ particles that were polymer grafted in Synthesis Example 8 (Example 5), 4.56 g of the Mg(OH)₂ particles that were polymer grafted in Synthesis Example 9 (Example 6), 5.00 g of the ZnO particles that were polymer grafted in Synthesis Example 10 (Example 7), 4.50 g of commercial surface-treated Mg(OH)₂ (Kisuma 5A, produced by Kyowa Chemical Industry) (Comparative Example 1), 4.50 g of untreated Mg(OH)₂ (Kisuma 5Q, produced by Kyowa Chemical Industry) (Comparative Example 2), 4.50 g of untreated ZnO (NanoTek, produced by C. I. Kasei Co., Ltd.) (Comparative Example 3), or 4.50 g of the ZnO surface treated in Synthesis Example 11 (Comparative Example 4) was added to a mixed resin composed of 3.60 g of epoxy resin (Epiclon N-740, produced by Dainippon Ink & Chemicals, Inc.) and 0.90 g of a curing agent (Novacure HX3722, produced by Asahi Kasei Corporation), thereby giving a resin composition.

Here, the amounts of Mg(OH)₂ added in the respective examples of the invention and the comparative examples were set, based on the method of calculation described below, so that amount of untreated Mg(OH)₂ itself included in each composition was the same. Similar calculations were carried out to set the amounts of ZnO addition as well.

Method of Calculation

The densities of 5 g of, respectively, the polymer grafted Mg(OH)₂ obtained in Synthesis Example 4, Kisuma 5A and Kisuma 5Q were measured with a gas pycnometer (Accupyc 1330, manufactured by Shimadzu Corporation; in helium). The results were 2.39 g/cm³ for both Kisuma 5A and Kisuma 5Q, and 2.35 g/cm³ for the polymer-grafted Mg(OH)₂ prepared in Synthesis Example 4.

Here, given that styrene has a density of 1.07 g/cm³ and acrylonitrile has a density of 0.81 g/cm³, the density of the styrene-acrylonitrile (7:3) copolymer in Synthesis Example 4 is 0.99 g/cm³. In addition, because untreated Mg(OH)₂ (Kisuma 5Q) has a density of 2.39 g/cm³, letting the styrene-acrylonitrile copolymer grafted volume per cubic centimeter be X cm³, we get the following:
0.99X+2.39(1−X)=2.35.
Thus, X is 0.026 cm³.

Therefore, the weight of grafted styrene-acrylonitrile copolymer per cubic centimeter is 0.026 cm³×0.99 g/cm³=0.026 g, and the weight of the Kisuma 5Q is (1−0.026) cm³×2.39 g/cm³=2.31 g.

Hence, the amount of grafted polymer on the above grafted Mg(OH)₂ as a proportion of the total is given by
100×0.026 g/2.31 g=1.2 wt %.

From the above, the amounts of Mg(OH)₂ present in 4.50 g of Kisuma 5A, in 4.50 g of Kisuma 5Q, and in 4.50 g of the polymer grafted Mg(OH)₂ prepared in Synthesis Example 4 are equivalent.

Calculations were similarly carried out for Synthesis Examples 5 to 10 as well. The amount of graft polymer relative to the overall polymer-grafted Mg(OH)₂ was respectively 4.9 wt % in Synthesis Example 5, 5.3 wt % in Synthesis Example 6, 4.4 wt % in Synthesis Example 7, 4.2 wt % in Synthesis Example 8, and 1.4 wt % in Synthesis Example 9. In Synthesis Example 10, the amount of graft polymer relative to the overall polymer-grafted ZnO was 11.2 wt %.

The resin compositions prepared in each of the above examples of the invention and comparative examples were formed into films by bar coating. The resulting films were dried overnight, then cured by 1 hour of heat treatment at 100° C. followed by 0.5 hour of heat treatment at 150° C. The acid resistances of the resulting cured films were evaluated. The results are shown in Table 2. The cured films all had a thickness of about 150 μm.
(1) Evaluation of Acid Resistance

A cured film having a length of 10 cm, a width of 5 cm, and a thickness of about 150 μm was immersed for 5 minutes in an aqueous solution containing 20 wt % of hydrogen chloride (Wako Pure Chemical Industries), washed with distilled water, then dried and the weight following immersion was measured.

The acid resistance was evaluated by calculating the percent weight loss from the weight before acid treatment and the weight after acid treatment, and was based also on the change in color of the cured film following acid treatment.

TABLE 2

| | Acid resistance (5 minutes) | | | |
|---|---|---|---|---|
| | Percent | | | |
| | weight | | Weight | |
| | loss | | loss | |
| | (%) | Color change | ratio | Rating |
| Example 1 | 0.1 | no change | 0.005 | good |
| Example 2 | 0.02 | no change | 0.001 | good |
| Example 3 | 0.02 | no change | 0.001 | good |
| Example 4 | 0.02 | no change | 0.001 | good |
| Example 5 | 0.02 | no change | 0.001 | good |
| Example 6 | 0.15 | no change | 0.007 | good |
| Example 7 | 0.08 | no change | 0.005 | good |
| Comparative Example 1 | 12 | slight whitening | 0.63 | NG |
| Comparative Example 2 | 19 | slight whitening | — | NG |
| Comparative Example 3 | 15 | slight whitening | — | NG |
| Comparative Example 4 | 10 | slight whitening | 0.67 | NG |

Good: The film had a high acid resistance
NG: The film lacked acid resistance

In above Table 2, the ratios of the physical property values in Examples 1 to 6 and Comparative Example 1 were calculated relative to the data for Comparative Example 2 (untreated Mg(OH)₂: Kisuma 5Q); that is, with the Comparative Example 2 data serving as the denominator.

Similarly, the ratios of the physical property values in Example 7 and Comparative Example 4 were calculated relative to the data for Comparative Example 3 (untreated ZnO: NanoTek); that is, with the Comparative Example 3 data serving as the denominator.

It is apparent from the results in Table 2 that the cured materials obtained from the compositions in Examples 1 to 7 of the invention containing the Mg(OH)₂ particles or ZnO particles having cyano group-containing graft polymer layers prepared in Synthesis Examples 4 to 10 all had an excellent acid resistance.

1. A resin composition, characterized by comprising a base material having a cyano group-bearing organic layer, and an organic resin.

2. The resin composition of claim 1 which is characterized in that the cyano group-bearing organic layer is composed of an organic substance having a cyano group equivalent weight per molecule of from 50 to 5,000.

3. The resin composition of claim 1 which is characterized in that the base material has a cyano group-bearing organic layer in an amount of at least 0.3 wt % based on the base material.

4. The resin composition of any one of claim 1 which is characterized in that the resin composition has a percent weight loss, when acid treated by 5 minutes of immersion in an aqueous solution containing 20 wt % of hydrogen chloride, which satisfies the following relationship with respect to the percent weight loss on similar acid treatment by an untreated base material-containing composition that includes, instead of the base material having a cyano group-bearing organic layer in said resin composition, a like amount (base material basis) of a base material lacking a cyano group-bearing organic layer: (percent weight loss of resin composition)/(percent weight loss of untreated base material-containing composition)<0.10.

5. The resin composition of claim 1 which is characterized in that the cyano group-bearing organic layer is chemically bonded to the base material.

6. The resin composition of any one of claim 1 which is characterized in that the base material is an inorganic substance.

7. The resin composition of claim 6 which is characterized in that the inorganic substance is one or more selected from the group consisting of alkaline earth metal carbonates, alkaline earth metal silicates, alkaline earth metal phosphates, alkaline earth metal sulfates, metal oxides, metal hydroxides, metal silicates and metal carbonates.

8. The resin composition of claim 7 which is characterized in that the inorganic substance is a metal hydroxide.

9. The resin composition of claim 8 which is characterized in that the metal hydroxide is one or more selected from the group consisting of magnesium hydroxide, potassium hydroxide and calcium hydroxide.

10. The resin composition of claim 1 which is characterized in that the base material is composed of particles having an average particle size of 1 nm to 100 μm.

11. The resin composition of claim 1 which is characterized in that at least part of the cyano group-bearing organic layer is a layer derived from (meth)acrylonitrile.

12. The resin composition of claim 1 which is characterized in that the cyano group-bearing organic layer was formed in an ionic liquid-containing solvent.

13. The resin composition of claim 1 which is characterized in that the cyano group-bearing organic layer is a polymer layer.

14. The resin composition of claim 13 which is characterized in that the polymer layer is a layer formed by graft polymerization.

15. The resin composition of claim 13 which is characterized in that the polymer layer is a layer composed of a polymer having a number-average molecular weight of from 1,000 to 5,000,000.

16. The resin composition of claim 13 which is characterized in that the polymer layer has an average thickness of at least 1 nm.
